(19) United States
(12) Patent Application Publication
(10) Pub. No.: US 2010/0072668 A1
(43) Pub. Date: Mar. 25, 2010

(54) Release Agents Containing Saponified Fatty and Rosin Acids or Derivatives Thereof

(76) Inventors: Marcel J.M. Andriessen, Lelystad (NL); Wouter Henk van der Meulen, Amstelveen (NL); Edwin Rene Hensema, Ermelo (NL)

Correspondence Address: ARIZONA CHEMICAL COMPANY;c/o Bo Segers, P.O. Box 550850, Jacksonville, FL, 32255, US

(21) Appl. No.: 12/634,189

(22) Filed: Dec. 9, 2009

Related U.S. Application Data
(62) Division of application No. 11/681,162, filed on Mar. 1, 2007.
(60) Provisional application No. 60/778,632, filed on Mar. 1, 2006.

(51) Int. Cl. B28B 7/38

(52) U.S. Cl. 264/300; 425/89

(57) ABSTRACT

The invention relates to compositions useful as release agents containing saponified fatty and/or rosin acids, as well as methods of making and using the same.

### RELATED APPLICATION DATA

This application claims priority from U.S. Provisional Application No. 60/778,632, filed Mar. 1, 2006, the specification of which is incorporated by reference.

### BACKGROUND OF THE INVENTION

1. Field of the Invention

The invention relates to compositions useful as release agents containing saponified fatty and/or rosin acids, products made therefrom, as well as methods of making and using such compositions and products. In another aspect, the present invention also relates to methods of pretreating a mold, to pretreated molds, to methods of operating a mold, to methods of molding, to molded articles, to molds, and to methods of making molded articles.

2. Description of the Related Art

Release agents, such as concrete mould release agents, are traditionally mineral oil based. Today, there is demand for bio-based products, which do not have the environmental and occupational health concerns of the mineral oil based products.

Accordingly, there is a need for a stable bio-based release agent composition without the deterioration of desired release properties, as well as products made therefrom, and methods of making and using such compositions and products.

### SUMMARY OF THE INVENTION

According to one non-limiting embodiment, there is provided a release agent composition. The composition includes a soap component comprising a saponified component comprising: (i) an at least partially saponified saturated or unsaturated, monocarboxylic aliphatic hydrocarbon or derivative thereof having a linear, branched, and/or cyclic chain, a dimer thereof, a trimer thereof; or (ii) an at least partially saponified mixture of rosin acids; and, a release enhancing component. The saponified component is present in an amount that is from 1 to 50 wt % based upon the total weight of the composition.

According to another non-limiting embodiment, there is provided a release agent composition, comprising from 8-15 wt % of saponified distilled tall oil; and, from 10 to 20 wt % alkyl ester of fatty acid or polymeric glycol fatty acid.

According to even another non-limiting embodiment, there is provided a mold construct. The construct includes a mold, moldable material, and release layer positioned between the mold and the moldable material. The release layer comprises: a soap component comprising a saponified component comprising: (i) an at least partially saponified saturated or unsaturated, monocarboxylic aliphatic hydrocarbon or derivative thereof having a linear, branched, and/or cyclic chain, a dimer thereof, a trimer thereof; or (ii) an at least partially saponified mixture of rosin acids; or, a release enhancing component. The saponified component is present in an amount that is from 1 to 50 wt % based upon the total weight of the composition.

According to one non-limiting embodiment, there is provided a method of making a molded article, comprising removing a molded article from a mold construct once the moldable material has at least partially dried and/or solidified. The mold construct comprises a mold, a moldable material, and a release layer positioned between the mold and the moldable material. The release layer comprises: a soap component comprising a saponified component comprising: (i) an at least partially saponified saturated or unsaturated, monocarboxylic aliphatic hydrocarbon or derivative thereof having a linear, branched, and/or cyclic chain, a dimer thereof, a trimer thereof; or (ii) an at least partially saponified mixture of rosin acids; or, a release enhancing component. The saponified component is present in an amount that is from 1 to 50 wt % based upon the total weight of the composition.

According to yet another embodiment of the present invention, there is provided a molded article made from the process as described above.

According to even still another embodiment of the present invention, there is provided a method of treating a mold. The method includes contacting at least a portion of the mold with a mold release composition.

### BRIEF DESCRIPTION OF THE DRAWINGS

FIGS. 1-4 depict embodiments of the present invention when a release layer contains the composition of the present invention and is used in mold construct to mold a moldable material into a molded article.

### DETAILED DESCRIPTION OF THE INVENTION

The present inventors have found such a composition that is commercially desired and solves some, if not all, of the above-mentioned problems. In some non-limiting embodiments, the composition of the present invention is a solution comprising bio-based raw materials. Using such raw materials is a much more cost effective and simplified process of making the release agent composition, especially compared to emulsifying vegetable oil or fatty acid esters. Further, the composition of the present invention is a bio-based solution, which would show equal or better performance compared to standard commercially available compositions. While the present invention is illustrated mainly by reference to concrete molding it finds utility in any type of molding environment.

The inventors have surprisingly found a composition that is relatively low cost and environmental friendly for use as a release agent in aqueous media. The composition contains biomass and/or byproducts thereof. Thus, the composition is a renewable resource.

As a broad description, with the particular components described in more detail below, the release agent of the present invention comprises (1) a soap component comprising a saponified component that comprises saponified monocarboxylic aliphatic hydrocarbon and/or saponified rosin acid; and/or (2) a release enhancing component. In some non-limiting embodiments, the soap further comprises a solution into which is dissolved the saponified component. It is believed that either the soap component or the release enhancing component alone can function as release agents, however, preferably, the release agent comprises both. The saponified component may comprise saponified monocarboxylic aliphatic hydrocarbon, or saponified rosin acid, however, preferably, the saponified component comprises both. In further non-limiting embodiments, the release agent may further include (3) surfactant(s) as necessary to form the composition into an emulsion, liquid, gel, solution, or any other state as desired for a particular application. More preferably, the release agent comprises: (1) a soap component comprising a solvent into which is dissolved the saponified component; and (2) a release enhancing component. Even more preferably, the release agent is an emulsion and comprises (1) a soap component comprising a solvent into which is dissolved the saponified component; and (2) a release enhancing component; and (3) a surfactant sufficient to emulsify the release agent.

This application is related to the field of chemistry, which is described, for example, in Kirk-Othmer “Encyclopedia of Chemical Technology”, fourth edition (1996), John Wiley & Sons, which is hereby incorporated, in its entirety, herein by reference.

Biomass products, such as those byproducts of refining and processes taking advantage of natural sources are usually low cost. Examples of a biomass product may be the byproducts of papermaking from trees. Accordingly, biomass products, such as those similar to black liquor solids, soaps, skimmings, as well as tall oil products such as pitch and/or distillate products thereof are examples of such biomass products. Further, such biomass products are predominantly environment friendly, especially as compared to those traditional release agents utilized.

The present invention relates to a composition containing at least one saturated or unsaturated, monocarboxylic aliphatic hydrocarbon. The saturated or unsaturated, monocarboxylic aliphatic hydrocarbon may have from 5 to 30 carbon atoms, preferably from 8 to 24 carbon atoms. The monocarboxylic aliphatic hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon and/or derivative thereof. Since the hydrocarbon is monocarboxylic, the derivative may be any commonly known derivative of a carbonyl-containing compound known in general Organic Chemistry Textbooks, such as “Organic Chemistry”, 5th Edition, by Leroy G. Wade, which is which is hereby incorporated, in its entirety, herein by reference.

Examples of derivatives of the saturated or unsaturated, monocarboxylic aliphatic hydrocarbon may be an ester, nitrile, or amine carboxylate thereof, as well as those commonly found in black liquor solids, soaps, skimmings, as well as tall oil products such as pitch and/or distillate products thereof. Again, the saturated or unsaturated, monocarboxylic aliphatic hydrocarbon may have from 5 to 30 carbon atoms, preferably from 8 to 24 carbon atoms. The monocarboxylic aliphatic hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein. Preferably, the derivative is an ester derivative such as for example those commercially available by Arizona Chemical Company as Uniflex products such as for example Uniflex 336 E and/or Uniflex 994.

The present invention relates to a composition containing at least one saturated or unsaturated, monocarboxylic aliphatic hydrocarbon and/or derivative thereof having a linear, branched, and/or cyclic chain. Again, the saturated or unsaturated, monocarboxylic aliphatic hydrocarbon may have from 5 to 30 carbon atoms, preferably from 8 to 24 carbon atoms. The monocarboxylic aliphatic hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon and/or derivative thereof having a linear, branched, and/or cyclic chain, a dimer thereof, a trimer thereof, and/or mixtures thereof. The composition may contain from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition. If the saturated or unsaturated, monocarboxylic aliphatic hydrocarbon and/or derivative thereof having a linear, branched, and/or cyclic chain, a dimer thereof, a trimer thereof, and/or mixtures thereof is part of a release agent composition, then the release agent composition contains from 0.1 to 99.9 wt % saturated or unsaturated, monocarboxylic aliphatic hydrocarbon and/or derivative thereof having a linear, branched, and/or cyclic chain, a dimer thereof, a trimer thereof, and/or mixtures thereof based upon the total weight of the composition as well.

The amount of saturated or unsaturated, monocarboxylic aliphatic hydrocarbon or derivative thereof having a linear, branched, and/or cyclic chain, a dimer thereof, a trimer thereof, or mixtures thereof, present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition, including any and all ranges and subranges therein. This is so even in instances where the saturated or unsaturated, monocarboxylic aliphatic hydrocarbon and/or derivative thereof having a linear, branched, and/or cyclic chain, a dimer thereof, a trimer thereof, and/or mixtures thereof is present in a release agent composition.

The saturated or unsaturated, monocarboxylic aliphatic hydrocarbon and/or derivative thereof having a linear, branched, and/or cyclic chain, a dimer thereof, a trimer thereof, and/or mixtures thereof may be any one or more found in biomass products, such as those similar to black liquor solids, soaps, skimmings, as well as tall oil products such as pitch and/or distillate products such as tall oil fatty acid, distilled tall oil, crude tall oil, and monomer.

The saturated or unsaturated, monocarboxylic aliphatic hydrocarbon may be a fatty acid. Examples of such include oleic, linoliec and/or stearic acids, including a derivative thereof; a linear, branched, and/or cyclic isomer thereof; a dimer thereof; and/or a trimer thereof.

The saturated or unsaturated, monocarboxylic aliphatic hydrocarbon or derivative thereof having a linear, branched, and/or cyclic chain, a dimer thereof, a trimer thereof, may be an acid having linear, branched, and/or cyclic C₁₈ chain. Examples of such may include linoliec and/or oleic acids or derivative thereof. Further examples may be linear, branched, and/or cyclic isomers of linoliec and/or oleic acids.

Examples of the saturated or unsaturated, monocarboxylic aliphatic hydrocarbon or derivative thereof having a linear, branched, and/or cyclic chain, a dimer thereof, a trimer thereof may be those found and described, for example in U.S. Pat. Nos. 6,875,842; 6,846,941; 6,344,573; 6,414,111; 4,519,952; and 6,623,554, which are hereby incorporated, in their entirety, herein by reference.

Finally, examples of the saturated or unsaturated, monocarboxylic aliphatic hydrocarbon or derivative thereof having a linear, branched, and/or cyclic chain, a dimer thereof, a trimer thereof may be caproic, enthanic, caprylic, capric, isodecyl, pelargonic, lauric, myristic, palmitic, oleic, linoleic, linolenic, stearic, isostearic, behenic, arachidic, arachidonic, erucic, azelaic, coconut, soya, tall oil, tallow, lard, neatsfoot, apricot, wheat germ, corn oil, cotton seed oil, ricinic, ricinoleic, rapeseed, palm kernel fatty acids, dimer acids, trimer acids, ozone acids, diacids, triacids, combinations and mixtures of these.

Commercially available sources of the saturated or unsaturated, monocarboxylic aliphatic hydrocarbon or derivative thereof having a linear, branched, and/or cyclic chain, a dimer thereof, a trimer thereof, or mixtures thereof are available. Preferable commercial sources are those offered by Arizona Chemical Company such as for example those of the Sylvaros, Sylvares, SylfatSoap, Sylvatal and/or Sylfat brands, including but not limited to Sylvatal 10, Sylfatsoap 15K, Sylvares 35F, Sylfat 2, Sylvaros 35F, and Sylvatal 10 Soap.

The present invention relates to a composition, which may contain at least one rosin acid compound. The rosin acid compound may be selected from those natural resin-based acids, such as those obtained from residues of distillation of natural oils. The rosin acid compound may also be derived. Since the rosin compound is an acid, the derivative may be any commonly known derivative of a carbonyl-containing compound known in general Organic Chemistry Textbooks, such as “Organic Chemistry”, 5th Edition, by Leroy G. Wade. Examples of such derivatives include, but are not limited to esters, amine carboxylates, and nitrile derivative of the rosin acid compound.

The rosin acids may include those that may be isolated from black liquor skimmings, crude tall oil, tall oil pitch, and distilled tall oil. In addition rosin acids may be those found in tall oil rosin, gum rosin and wood rosin. These naturally occurring rosins may be suitable mixtures and/or isomers of monocarboxylic tricyclic rosin acids usually, but not limited to, those containing 20 carbon atoms. The tricyclic rosin acids differ mainly in the position of the double bonds. The rosin acid may be at least one of levopimaric acid, neoabietic acid, palustric acid, abietic acid, dehydroabietic acid, seco-dehydroabietic acid, tetrahydroabietic acid, dihydroabietic acid, pimaric acid, paulstric acid, and isopimaric acid, or mixtures, isomers, and/or derivatives thereof. The rosins derived from natural sources also include rosins, i.e. rosin mixtures, modified notably by polymerisation, isomerisation, disproportionation and hydrogenation. The rosin acids may include those mentioned in U.S. Pat. Nos. 6,875,842; 6,846,941; 6,344,573; 6,414,111; 4,519,952; and 6,623,554, which are hereby incorporated, in their entirety, herein by reference.

The composition may contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the composition. If the rosin acid compound(s) selected from the group consisting of natural resin-based acids obtained from residues of distillation of natural oils, amine carboxylates and ester and nitrile compounds of these acids is part of a release agent composition, then the release agent composition contains from 0.1 to 99.9 wt % rosin acid compound selected from the group consisting of natural resin-based acids obtained from residues of distillation of natural oils, amine carboxylates and ester and nitrile compounds of these acids based upon the total weight of the composition as well.

The amount of rosin acid compound selected from the group consisting of natural resin-based acids obtained from residues of distillation of natural oils, amine carboxylates and ester and nitrile compounds of these acids present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition, including any and all ranges and subranges therein. This is so even in instances where the rosin acid compound selected from the group consisting of natural resin-based acids obtained from residues of distillation of natural oils, amine carboxylates and ester and nitrile compounds of these acids.

The source of rosin acid compound mentioned above may be any commercially available source. In many instances, the monocarboxylic aliphatic hydrocarbon and the rosin acid are found in the same product. As a non-limiting example, distilled tall oil may contain both the monocarboxylic aliphatic hydrocarbon and the rosin acid, generally in the range of about 99.5 to 65 wt % monocarboxylic aliphatic hydrocarbon, and in the range of about 0.5 to about 35 wt % rosin acid, preferably in the range of about 98 to 70 wt % monocarboxylic aliphatic hydrocarbon, and in the range of about 2 to about 30 wt % rosin acid, more preferably in the range of about 95 to 80 wt % monocarboxylic aliphatic hydrocarbon, and in the range of about 5 to about 20 wt % rosin acid, and even more preferably in the range of about 95 to 85 wt % monocarboxylic aliphatic hydrocarbon, and in the range of about 5 to about 15 wt % rosin acid.

The amount of saponified component in the present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition, including any and all ranges and subranges therein. The saponified component will preferably comprise in the range of about 1 to about 50 wt %, more preferably in the range of about 1 to about 40% wt, even more preferably in the range of about 1 to about 30 wt %, still more preferably in the range of about 3 to about 20 wt %, and yet more preferably in the range of about 5 to about 15 wt %, based upon the total weight of the composition.

The present invention relates to a composition that may optionally contain at least one unsaponifiable material. Examples of unsaponifiable materials is found, but not limited to, those described in U.S. Pat. Nos. 6,465,665; 6,462,210; and 6,297,353 which are hereby incorporated, in their entirety, herein by reference. Unsaponifiable material may be any neutral material that is not capable of being saponified, or ester thereof.

Examples of the unsaponifiable components include, but are not limited to, tocopherols, tocotrienols, carotenoids, vitamin A, vitamin K, vitamin D, lipoproteins, cholesterol, provitamins, growth factors, flavonoids, sterols, stilbenes, squalane, oryzanol and lycopene. Unsaponifiable material may include those mentioned in U.S. Pat. Nos. 6,875,842; 6,846,941; 6,344,573; 6,414.111; 4,519,952; and 6,623,554, which are hereby incorporated, in their entirety, herein by reference.

Further examples of such unsaponifiable materials are those found in plants, such as woody plants, preferably trees. Examples of such include, but are not limited to sterols, stanols, polycosanols, 3,5-sitostadiene-3-ona, 4-stigmasten-3-ona, α- and/or β-sitosterols, α- and/or β sitostanols, Campestanol, Campesterol, Cycloartenol, Docosanol. Eicosanol, Ergosterol, Escualene, Fatty alcohol esters, Sterol esters, Hexacosanol, Methyl encycloartenol, Pimaral, Pimarol, Stigmasta-3-ona, Tetracosanol, etc.

The present invention relates to a composition containing not more than 75 wt % of unsaponifiable material based upon the total weight of the composition. If the unsaponifiable material is part of a release agent composition, then the release agent composition contains not more than 75 wt % unsaponifiable material based upon the total weight of the composition as well. The amount of unsaponifiable material present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, and 75 wt % based upon the total weight of the composition. This is so even in instances where the unsaponifiable material is present in a release agent composition.

Commercially available sources of the unsaponifiable material are available. Preferable commercial sources are those offered by Arizona Chemical Company such as for example those of the Sylvaros, Sylvares, SylfatSoap, Sylvatal and/or Sylfat brands, including but not limited to Sylvatal 10, Sylfatsoap 15K, Sylvares 35F, Sylfat 2, Sylvaros 35F. and Sylvatal 10 Soap.

The composition may have any pH from 1 to 14, including 1, 2, 3, 4, 5, 6, 7, 8, 9, 10, 11, 12, 13, and 14, including any and all ranges and subranges therebetween. Preferably, the composition is a release agent composition at a pH of not less than about 7, more preferably about 7 to 10, most preferably from about 7.5 to about 9.5. The pH may preferably be 7.1, 7.2, 7.4, 7.5, 7.6, 7.8, 8.0, 8.2, 8.5, 8.6, 8.8, 9.0, 9.1, 9.2, 9.3, 9.4, 9.5, 9.7, and 10, including any and all ranges and subranges therebetween.

The composition may have an acid value. Preferably acid values include those greater than 10, including greater than or equal to 10, 11, 12, 13, 14, 15, 20, 25, 30, 35, 40, 45, 50, 55, 60, 65, 70, 75, 80, 85, 90, 95, 100, 105, 110, 120, 125, 130, 140, 150, 160, 170, 180, 190, and 200, including any and all ranges and subranges therebetween. Preferably, the acid value of the composition is greater than or equal to 40.

When the composition contains at least one of the monocarboxylic aliphatic hydrocarbon, rosin acid, and/or unsaponifiable material, preferably each may be sourced from the residues of distillation of natural oils. Preferable those natural oils that are extracted from resinous trees, vegetables, and/or tallow. More preferably, the source of the hydrocarbon, rosin acid, and/or unsaponifiable material is tall oil pitch, tall oil, crude tail oil, monomer, distilled tall oil, or mixtures thereof.

The composition may include a solvent. The solvent may be a hydrophilic solvent, such as water, and/or a hydrophobic solvent and/or an organic solvent and/or mixtures thereof. Preferably, the solvent contains water, and more preferably the solvent is a aqueous solvent. The solvent may be biodegradable, and/or environmentally friendly. The solvent may be present in any suitable amount.

The amount of solvent will be selected to provide an emulsion, liquid, gel or any other state as desired. For example it may be desired for the composition to be in gel form during transportation to reduce shipping costs, with additional solvent added to create a liquid or emulsion composition post-shipping. Generally, for liquid compositions the amount of solvent will be sufficient to dilute the soap component material to 50, 40, 30, 20, or even 10 weight percent saponified component, based on the weight of solvent and saponified component. Gel compositions will have less solvent.

The amount of solvent in the present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition, including any and all ranges and subranges therein. The solvent will preferably comprise in the range of about 1 to about 95 wt %, more preferably in the range of about 20 to about 90% wt, even more preferably in the range of about 40 to about 90 wt %, still more preferably in the range of about 50 to about 90 wt %, and yet more preferably in the range of about 60 to about 85 wt % of the composition, based upon the total weight of the composition.

More preferably, the monocarboxylic aliphatic hydrocarbon and rosin acid are at least partially saponified. The % saponification may be from 1 to 100%, preferably greater than 50% saponified, more preferably at least 75% saponified, even more preferably at least 90% saponified, still more preferably at least 95% saponified, and most preferably 100% saponified, based on the total amount of monocarboxylic aliphatic hydrocarbon and/or rosin acid. This range includes 1, 5, 10, 15, 20, 25, 30, 35, 40, 45, 50, 55, 60, 65, 70, 75, 80, 85, 90, 95, and 100% saponification, based upon the total amount of hydrocarbon and/or rosin acid, including any and all ranges and subranges therein.

In addition, the monocarboxylic aliphatic hydrocarbon may be at least partially saponified. The % saponification may be from 1 to 99%, preferably greater than 50% saponified, more preferably at least 75% saponified, even more prefereably at least 90% saponified, still more preferably at least 95% saponified, and most preferably 100% saponified, based on the total amount of monocarboxylic aliphatic hydrocarbon. This range includes 1, 5, 10, 15, 20, 25, 30, 35, 40, 45, 50, 55, 60, 65, 70, 75, 80, 85, 90, 95, and 100% saponification, based upon the total amount of monocarboxylic aliphatic hydrocarbon, including any and all ranges and subranges therein.

In addition, the rosin acid may be at least partially saponified. The % saponification may be from 1 to 99%, preferably greater than 50% saponified, more preferably at least 75% saponified, even more preferably at least 90% saponified, still more preferably at least 95% saponified, and most preferably 100% saponified, based on the total amount of rosin acid. This range includes 1, 5, 10, 15, 20, 25, 30, 35, 40, 45, 50, 55, 60, 65, 70, 75, 80, 85, 90, 95, and 100% saponification, based upon the total amount of rosin acid, including any and all ranges and subranges therein.

The mixture of the monocarboxylic aliphatic hydrocarbon, rosin acid, and unsaponifiable material may be solid, semisolid, liquid, or mixtures thereof. The mixture may be in any state, except that of a 100% gaseous state. If the mixture is a solid and/or semisolid and/or liquid, it may be, in part, in the form of a particle. The particle size may have any size in any axis. Preferably, the particle may be from about 0.01 nm to about 100 microns, more preferably from about 0.1 nm to about 10 microns, and most preferably from about 1 nm from 1 to 1000 nm along at least one axis. The particle may be 1, 2, 3, 4, 5, 10, 15, 20, 25, 30, 35, 40, 45, 50, 55, 60, 65, 70, 75, 80, 85, 90, 100, 125, 150, 175, 200, 250, 300, 350, 400, 450, 500, 550, 600, 650, 700, 750, 800, 850, 900, 950, and 1000 nm along at least one axis. When a plurality of particles exists, the above size in any axis may be the average size in any axis.

When the composition contains an organic solvent, the pH of the composition may be any pH and the mixture of the monocarboxylic aliphatic hydrocarbon, rosin acid, and unsaponifiable material may be partially or fully solubilized therein. Preferably, the mixture of the monocarboxylic aliphatic hydrocarbon, rosin acid, and unsaponifiable material is either fully solubilized therein the organic solvent or a partial suspension, dispersion, gel, emulsion, or sol therewith.

In addition, the monocarboxylic aliphatic hydrocarbon, rosin acid, and unsaponifiable material mixture may be a colloid. The mixture may be hydrophobic or hydrophilic or mixtures thereof, preferably hydrophobic. Still further, the mixture may be a discontinuous phase in contact with a continuous phase, preferably being the hydrophilic, hydrophobic and/or organic solvent. The combination of the mixture and the continuous phase may form a full and/or partial solution, suspension, dispersion, gel, emulsion, or sol.

When the composition is a full and/or partial solution, suspension, dispersion, emulsion, or sol in a hydrophilic and/or hydrophobic solvent, the mixture and/or particle may be present from 1-100 wt % by weight in solution. Preferably, the composition is an emulsion. The amount of mixture in the suspension, dispersion, gel, emulsion, or sol may be 1, 2, 5, 10, 15, 20, 25, 30, 35, 40, 45, 50, 55, 60, 65, 70, 75, 80, 85, 90, 95, and 100% by weight, including any and all ranges and subranges therein. Preferably, when the monocarboxylic aliphatic hydrocarbon is at least partially saponified, the saponified monocarboxylic aliphatic hydrocarbon portion is present in an amount from 1 to 100 wt %, preferably greater than 20 wt %, more preferably greater than 30 wt %, even more preferably greater than 50 wt %, still more preferably greater than 70 wt %, yet more preferably greater than 90%, and even still more preferably 100% saponified, based upon the total amount of monocarboxylic aliphatic hydrocarbon in the composition, including any and all ranges and subranges therein. This range includes, 1, 2, 3, 4, 5, 6, 7, 8, 9, 10, 11, 12, 13, 14, 15, 16, 17, 18, 19, 20, 15, 30, 35, 40, 45, 50, 55, 60, 65, 70, 75, 80, 85, 90, 95, and 100 wt % based upon the total weight of the composition, including any and all ranges and subranges therein. Also preferably, when the rosin acid is at least partially saponified, the saponified rosin acid portion is present in an amount from 0.001 to 100 wt %, preferably at least 20 wt %, more preferably at least 30 wt %, even more preferably at least 50 wt %, still more preferably at least 70%, yet more preferably at least 90%, and even still more preferably 100% saponified, based upon the total amount of rosin acid in the composition, including any and all ranges and subranges therein. This range includes 0.001, 0.005, 0.01, 0.05, 0.1, 0.5, 1, 2, 3, 4, 5, 6, 7, 8, 9, 10, 11, 12, 13, 14, 15, 16, 17, 18, 19, 20, 15, 30, 35, 40, 45, 50, 55, 60, 65, 70, 75, 80, 85, 90, 95, and 100 wt % based upon the total weight of the composition, including any and all ranges and subranges therein.

The composition of the present invention may optionally contain at least one base. While any base is feasible, preferably bases include sodium, potassium or ammonium-containing bases. Specific examples my include hydroxides of sodium, potassium or ammonium. When the base is added to the composition, at least a portion of the resultant ions from the base is thought to form a salt therein. While the ions may be located anywhere within the composition, the ions may be contained within the particle, discontinuous phase, continuous phase, or entire release agent composition mentioned above. Preferably, the base at least partially saponifies the monocarboxylic aliphatic hydrocarbon and/or rosin acid that is present in the composition, with the amount of saponification be at least 75%, preferably at least 90%, more preferably at least 95%, and most preferably 100%. Ranges of saponification include 1, 5, 10, 15, 20, 25, 30, 35, 40, 45, 50, 55, 60, 65, 70, 75, 80, 85, 90, 95, and 100% saponification, including any and all ranges and subranges therein.

The composition may contain from 0 to 20 wt % of the base, preferably less than 15 wt %, more preferably less than 10 wt % of the base based upon the total weight of the composition. The amount of base may be 0, 0.001, 0.005, 0.01, 0.05, 0.1, 0.5, 1, 2, 5, 10, 15, and 20 wt %, including any and all ranges and subranges therein.

In a preferred embodiment, the composition of the present invention may be made by contacting the base with a solvent, such as water, and then simultaneously and/or directly thereafter contacting a composition containing the monocarboxylic aliphatic hydrocarbon, rosin acid, and optionally unsaponifiable material, in a manner that at least partially if not fully saponifies the monocarboxylic aliphatic hydrocarbon and/or rosin acid. Ranges of saponification include 1, 5, 10, 15, 20, 25, 30, 35, 40, 45, 50, 55, 60, 65, 70, 75, 80, 85, 90, 95, and 100% saponification, including any and all ranges and subranges therein.

In an additional preferred embodiment, the composition of the present invention may be made by contacting the base with a solvent, such as water, and then simultaneously and/or directly thereafter contacting a composition containing the monocarboxylic aliphatic hydrocarbon, rosin acid, and optionally unsaponifiable material, in a manner that fully saponifies the monocarboxylic aliphatic hydrocarbon and/or rosin acid, followed by further contacting of the solvent-base mixture with a composition containing further monocarboxylic aliphatic hydrocarbon, further rosin acid, and optionally further unsaponifiable material, to form a composition containing at least partially if not fully saponified monocarboxylic aliphatic hydrocarbon and/or partially saponified rosin acid.

The composition of the present invention may optionally contain a surfactant. In some embodiments, it is desirable to utilize a surfactant suitable to form an emulsion of the release enhancing component and the soap component. While ionic, cationic, anionic, amphoteric, and nonionic surfactants are suitable, the most preferred surfactants are biologically friendly surfactants. A wide range of surfactants can be used in the composition of the present invention. A typical listing of anionic, nonionic, cationic, ampholytic and zwitterionic classes, and species of these surfactants, is given for example in U.S. Pat. Nos. 3,664,961 and 6,916,777, which are hereby incorporated, in their entirety, herein by reference. Amphoteric surfactants are also described in detail in “Amphoteric Surfactants, Second Edition”, E. G. Lomax, Editor (published 1996, by Marcel Dekker, Inc.) McCutcheon's, Emulsifiers and Detergents, Annually published by M. C. Publishing Co., and Surface Active Agents and Detergents” (Vol. I and II by Schwartz, Perry and Berch), which are hereby incorporated, in their entirety, herein by reference.

In a preferred embodiment, the composition optionally contains a surfactant. More preferably, the surfactant may be an esterified glycol. An example of an esterified glycol is polyethylene glycol monooleates such as PEG200 Monooleate.

Non-limiting examples of suitable surfactants include the following available from Kao Chemicals: Amidet TEC N, Akyporox RLM80V, Akyporox RLM40V, Akypo RO20, Akypo RO50, Akypo RO90, Akypo LF4, TEC AN, Fosfodet FJZ903, TAMEA 20, Amed A15, Akypo Gene CL756, Akypo Soft 45, and Ethoxylated Glycerine, and include the following available from Elementis Specialties: Serdox NOG440, Servo CM6030, and Serdox NOL3

While the surfactant may be located anywhere within the composition, the surfactant may be contained within the particle, discontinuous phase, continuous phase, or entire release agent composition mentioned above. Preferably the surfactant is added in a manner that provides stability to the above-mentioned particle in a discontinuous phase. The composition may contain from 0.1 to 20 wt % of the surfactant, preferably from 0.1 to 15 wt %, more preferably from 0.1 to 10 wt %, even more preferably from 0.5 to 5 wt %, and still more preferably from 1 to 4 wt % of the base, based upon the total weight of the composition. The amount of surfactant may be 0, 0.001, 0.005, 0.01, 0.05, 0.1, 0.5, 1, 2, 5, 10, 15, and 20 wt %, including any and all ranges and subranges therein.

The composition may include a release enhancing component. Non-limiting examples of release enhancing components suitable for use in the present invention include, but are not limited to, fatty acid esters, glycols, diols, fatty alcohols, polymeric glycols including but not limited to polyethylene glycol and polypropylene glycol, silicon oil, mineral oil, vegetable oil, epoxidized vegetable oils, triglycerides, animal derived oils, fatty acids, and dimer and trimer fatty acids, and esterified derivatives of any of the forgoing.

The composition may contain from 1 to 40 wt % of the release enhancing component, preferably from 5 to 30 wt %, more preferably from 10 to 30 wt %, and even more preferably from 10 to 20 wt %, based upon the total weight of the composition. The amount of release enhancing component may be 0, 0.001, 0.005, 0.01, 0.05, 0.1, 0.5, 1, 2, 5, 10, 15, 20, 30, and 40 wt %, including any and all ranges and subranges therein.

Preferably, the release enhancing component is a fatty acid ester, non-limiting examples of which include alkyl esters of fatty acid. Generally, the alky group will comprise in the range of about 1 to about 20 carbons atoms, preferably in the range of about 1 to about 8 carbon atoms, more preferably in the range of about 1 to about 4 carbon atoms. The more preferred alkyl groups are methyl, ethyl, propyl and butyl, with a preferred alkyl ester of fatty acid being butyl ester of a fatty acid (a non-limiting commercial example of which is Uniflex 306E).

If both the saponified component and a release enhancing component is present, there is preferably more weight of release enhancing component. Generally, the weight ratio of release enhancing component to saponified component is from 0.01-99.99:99.99-0.01, preferably from 60-99.99:0.01-40, more preferably from 70-95:5-30.

Expressed in terms of a soap comprising solvent having a saponified component dissolved therein, there is generally more soap. Expressed in terms of a soap comprising solvent having a saponified component dissolved therein, generally, the weight ratio of soap component to release enhancing component is from 0.01-99.99:99.99-0.01, preferably from 60-99.99:0.01-40, more preferably from 70-95:5-30. As a nonlimiting example, a release composition may comprise an amount that is approximately 85 wt % of the diluted saponified DTO to about 15 wt % of the esterified fatty acid.

The composition may be required to be stable and/or perform at low temperatures. Therefore, the freezing and/or cloud point of the composition may be required to be reduced. Accordingly, the composition may optionally include a freezing and/or cloud point suppressant and/or a low temperature stabilizer (LTS). Any freezing and/or cloud point suppressant and/or LTS is sufficient. Preferable freezing and/or cloud point suppressants include glycols and glycerols. Examples of glycols and glycerols may be but is not limited to polyethylene glycols (PEG), triethylene glycol, and glycerol, as well as propylene and/or ethylene glycol. Further examples of solvent include alcohols and/or polyols. Examples of such alcohols include lower alkyl alcohols including isopropyl alcohol and propanediol. Further examples of LTS's are polyamides. Some preferred examples of polyamides, their compositions, and methods of making the polyamides which are contained by the composition of the present invention are those found, for example, in U.S. Pat. Nos. 5,645,632; 5,783,657; 5,998,570; 6,268,466; 6,399,713; 6,492,458; 6,552,160; 5,981,680; 4,816,549; 6,870,011; and 6,864,349. as well as US Published Patent Application 20040186263, which are hereby incorporated, in their entirety, herein by reference. The more preferred polyamides are Ester-Terminated PolyAmides (ETPAs), Tertiary-Amide-Terminated PolyAmides (ATPAs), Ester-Terminated PolyEster-Amides (ETPEAs), PolyAlkyleneOxy-terminated PolyAmides (PAOPAs), and PolyEther-PolyAmides (PEPAs), most preferably ETPA, ETPEAs, and ATPAs. Further non-limiting examples of suitable LTS compounds include any discloses in U.S. Patent Publication No. 2006-0229222, which is incorporated herein.

When the composition of the present invention contains a freezing and/or cloud point suppressant and/or a low temperature stabilizer (LTS), the composition contains from 0.001 to 15 wt %, preferably from 0.1 to 10 wt %, of the freezing and/or cloud point suppressant and/or the low temperature stabilizer (LTS). This range includes, but is not limited to, 0.001, 0.005, 0.01, 0.05, 0.1, 0.5, 1, 1.5, 2, 2.5, 3, 3.5, 4, 4.5, 5, 6, 7, 8, 9, 10, 11, 12, 13, 14, and 15 wt % of the freezing and/or cloud point suppressant and/or the low temperature stabilizer (LTS) based upon the total weight of the composition, including any and all ranges and subranges therein.

The composition of the present invention may also contain other additives such as defoamers, retardants, as well as other additives commonly known in the art of release agents, moldings and moldable materials. Defoamers act to reduce the amount of foam present in the composition during production, use, transportation, handling, etc. Retardants function to keep at least a portion of moldable materials from fully solidifying altogether and/or to reduce the rate at which at least a portion of moldable materials solidify. The composition may also contain shelf life enhancers, preservatives, fungicides and/or biocides.

The composition of the present invention may be useful as a release agent composition, preferably a release agent that provides for a mold surface to be easily cleaned and/or having low dust and residue buildup once the moldable material is removed from the mold and provides for a surface of the moldable material that is smooth and clean containing no artifacts bestowed onto it by the presence of the release agent. Accordingly, the present invention relates to a method of applying and/or contacting the release agent composition of the present invention between a mold and a moldable material. A preferred moldable material is concrete. The composition of the present invention does not necessarily have to be placed in contact with one or both of the mold and/or moldable material so long as it is located between the mold and the moldable material. In fact, other materials may be in contact with the release agent composition of the present invention. Examples of other materials may be retardants. Therefore, a retardant layer may be present in between the mold and the moldable material and located in a place so that the release agent is not in contact with the one or more surfaces of the mold and/or moldable material. In a preferred embodiment, the release agent composition is in contact with at least a portion of a surface of a mold. In a separate preferred embodiment, the release agent composition is in contact with at least a portion of a surface of the moldable material. In yet another embodiment of the present invention, the release agent composition is in contact with at least a portion of a surface of the mold and in contact with at least a portion of a surface of the moldable material. The portions of the mold and moldable material may be any portion, including total planar surface area portions thereof each surface of the mold and moldable material respectively.

The present invention includes a method of pretreating a mold by applying the release agent of the present invention to at least a portion of the mold. It should be understood that the release agent may be applied to the mold in any suitable manner, non-limiting examples of which include spraying, pouring, wiping, brushing, roll application, misting, dripping, bringing the mold into contact with the release agent, and/or dipping the mold into the release agent.

The present invention also includes a mold having the release agent of the present invention on at least a portion of the mold.

The present invention even also includes an article comprising the mold, moldable material supported by the mold, and release agent positioned between the mold and moldable material.

The mold may be for molding any moldable material into any shape. While the mold may be made of any material, it is preferably made from metal, alloy, steel, wood, polymers, and plastic.

The moldable material may be any moldable material. Preferably, the moldable material is concrete, oriented strand board, plastic, polymers, metal, or alloy.

The release agent may be used in any molding methodology commonly known in the art including concrete molding, metal and alloy molding, oriented strand board molding, plastic molding, plastic extrusion, sheet manufacturing, plastic article manufacturing, wood-based product molding, polymer-based product molding.

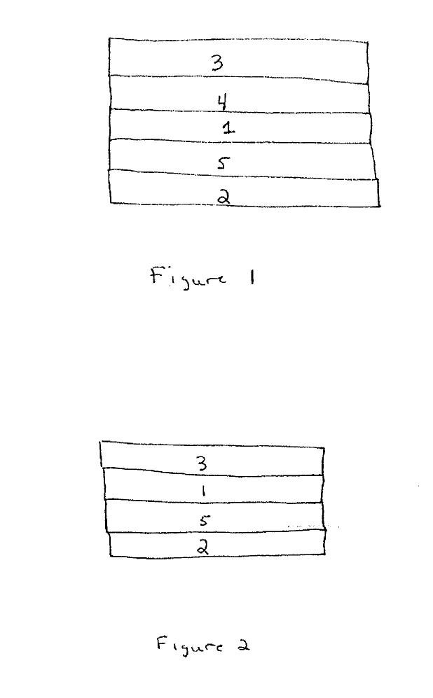

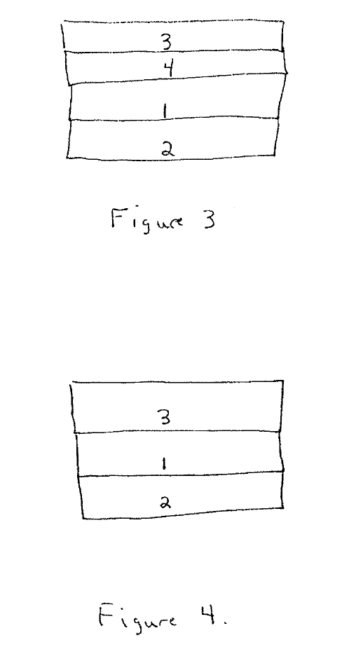

FIGS. 1-4 depict embodiments of the present invention when a release layer contains the composition of the present invention and is used in mold construct to mold a moldable material into a molded article. FIG. 1 demonstrates a release layer containing the composition of the present invention 1, located between the mold surface 2 and a surface of the moldable material 3. One or more optional layers 4 and/or 5 may be located between the release layer containing the composition of the present invention 1 and the surface of the mold 2 and/or between the release layer containing the composition of the present invention 1 and the moldable material 3, respectively. These optional layers may be optional functional layers and may be functionally equivalent, such as for example, layers containing retardants. Also, there could be more than one optional layer located between the release layer and the mold. Also, there could be more than one optional layer between the release layer and the moldable material. One or both of the optional layers may be removed. FIG. 2 demonstrates when one or more optional layers 4 is not present. FIG. 3 demonstrates when one or more optional layers 5 is not present. FIG. 4 demonstrates when one or more optional layers 4 and 5 are not present.

The mold construct of the present invention may be used in any conventional manufacturing method of making molded articles. Preferably, the moldable material is at least partially dried and/or solidified while in the mold construct of the present invention. The duration of time for drying and/or solidification may be any time common in the art of molding and/or art of manufacturing molded articles so long as a least a portion of the moldable material is dried and/or solidified.

The present invention is explained in more detail with the aid of the following embodiment examples.

### EXAMPLES

### Example 1

Sylfatsoap 15K was evaluated with good results as a release agent in combination with a retarder which is used to make graveled concrete tiles. Adherence was low with this product and additional adherence was provided by adding a small amount of rosin soap, i.e Sylvaros 35F. Testing of Sylfatsoap 15K, i.e. experiment 2 in table 1, and a mixture of SylfatSoap 15K and Sylvaros 35F, i.e. experiment 3 in table 1, without retardant showed however poor results. Also, the addition of Sylvaros 35F had a negative impact on the Mould Appearance after concrete removal.

TABLE 1
Sample preparation and evaluation (Degussa is now BASF).

| | | | | | | Mould | |
|---|---|---|---|---|---|---|---|
| | | | | | Release Agent | Appearance | |
| | | | | | Appearance | after concrete | Concrete element |
| | Composition | | | | fluid/thick | removal | appearance |
| | Potassium salt | Sodium salt of | Total | | clear/turbid | + = clean | + = smooth surface |
| | of Sylfat2 | rosin | Solids | Water | homogeneous/phase | +/− = little built up | +/− = some stripes |
| Number | (wt. %) | (wt. %) | (wt. %) | (wt. %) | separation | − = severe built up | − = severe stripes |
| 1 | | | | | fluid/turbid/homogeneous | + | + |
| 2 | 15.0 | | 15.0 | 85.0 | fluid/clear/homogeneous | +/− | +/− |
| 3 | 14.6 | 0.9 | 15.5 | 84.5 | fluid/clear/homogeneous | − | +/− |

| | |
|---|---|
| Release agent appearance: | Appearance of the concrete release agent after 24 hrs |
| Mould Appearance after concrete removal | After the concrete element is removed out the mould some concrete may |
| | remain in te mold. This is referred to as built up. |
| Concrete element Appearance | After removel from the mould the element istself is evauated on its appearance. |

### Sylfatsoap 15K Mixtures

Mixtures of SylfatSoap 15K with Fatty Acid Esters, glycerol or propanediol were made and evaluated, see table 2, experiments 4 through 13, with mixed results. In a number of cases, concrete elements were produced with streaks. Without being limited by theory, this is believed to be due to too poor flow properties of the release agent after application to the mould. In other words, after water evaporation, an even mould surface must be obtained which is free of streaks. The learning from the above experiments was that an even surface with less streaks can be best obtained if the release agent is still liquid after water evaporation. In other words, the concrete release agent should still have some flow properties after water evaporation to reduce the amount of streaks and to obtain a concrete element with an even surface. In the experiments 4 through 13, various additives were evaluated to improve the flow properties.

TABLE 2
Sample preparation and evaluation.

| | | | | | | | | | Mould | |
|---|---|---|---|---|---|---|---|---|---|---|
| | | | | | | | | Release Agent | Appearance | |
| | Composition | | | | | | | Appearance | after concrete | Concrete element |
| | Potassium | | | | | | | fluid/thick | removal | appearance |
| | salt | Ester | Ester | | | Tota | | clear/turbid | + = clean | + = smooth surface |
| | of Sylfat2 | (1) | (2) | Glycerol | Propanediol | Solids | Water | homogeneous/phase | +/− = little built up | +/− = some stripes |
| Number | (wt. %) | wt. % | wt. % | wt. % | wt. % | (wt. %) | (wt. %) | separation | − = severe built up | − = severe stripes |
| 4 | 14.4 | 6.0 | | | | 20.4 | 79.6 | fluid/clear/homogeneous | +/− | +/− |
| 5 | 13.5 | 10.0 | | | | 23.5 | 76.5 | fluid/clear/homogeneous | − | − |
| 6 | 12.0 | 20.0 | | | | 32.0 | 68.0 | fluid/turbid/homogeneous | − | − |
| 7 | 14.4 | | 6.0 | | | 20.4 | 79.6 | fluid/turbid/homogeneous | | |
| 8 | 13.5 | | 10.0 | | | 23.5 | 76.5 | fluid/turbid/homogeneous | − | + |
| 9 | 12.0 | | 20.0 | | | 32.0 | 68.0 | fluid/turbid/homogeneous | − | − |
| 10 | 14.3 | | | 5.0 | | 19.3 | 80.8 | fluid/clear/homogeneous | +/− | − |
| 11 | 13.5 | | | 10.0 | | 23.5 | 76.5 | fluid/clear/homogeneous | +/− | − |
| 12 | 14.3 | | | | 5.0 | 19.3 | 80.8 | fluid/clear/homogeneous | +/− | − |
| 13 | 13.5 | | | | 10.0 | 23.5 | 76.5 | fluid/clear/homogeneous | +/− | − |

| Number | Sample Composition |
|---|---|
| 4 | Made by mixing SylfatSoap 15K from example 1 with Uniflex 336E |
| 5 | Made by mixing SylfatSoap 15K from example 1 with Uniflex 336E |
| 6 | Made by mixing SylfatSoap 15K from eample 1 with Uniflex 336E |
| 7 | Made by mixing SylfatSoap 15K from example 1 with Uniflex 994 |
| 8 | Made by mixing SylfatSoap 15K from example 1 with Uniflex 994 |
| 9 | Made by mixing SylfatSoap 15K from example 1 with Uniflex 994 |
| 10 | Made by mixing SylfatSoap 15K from example 1 with Glycerol |
| 11 | Made by mixing SylfatSoap 15K from example 1 with Glycerol |
| 12 | Made by mixing SylfatSoap 15K from example 1 with Propanediol |
| 13 | Made by mixing SylfatSoap 15K from example 1 with Propanediol |

| | |
|---|---|
| Ester (1) | Uniflex 336E |
| Ester (2) | Uniflex 994 |

| | |
|---|---|
| Release agent appearance: | Appearance of the concrete release agent after 24 hrs |
| Mould Apperance after concrete removal | After the concrete element is removed out the mould some concrete may remain in te mold. |
| | This is referred to as built up. |
| Concrete element Appearance | After removal from the mould the element istself is evauated on its appearance. |

### Sylvatal 10 Soaps

In experiments 14 through 26 soaps were made from DTO to further boost the release properties. Instead of Sylfat2, soaps from DTO, i.e. Sylvatal10, were made and evaluated. Soaps were made with an excess of unsaponified Sylvatal 10 between 2 and 6 wt %, see table 3, in various proportions with saponified Sylvatal10. Unsaponified DTO is an oily liquid and is believed to improve concrete release flow properties after water evaporation. Samples were made with and without Glycerol and PEG200. The best results were obtained with a concrete release agent with 15 wt % or 10 wt % saponified Sylvatal10 and 4 or 6 wt % unsaponified Sylvatal 10 containing PEG200 or glycerol.

These last experiments are limited to the evaluation of PEG200 and Glycerol. It is clear, that it is possible that more and other additives could improve the performance of release agents based on a mixture of saponified and unsaponified Sylvatal 10.

TABLE 3
Sample preparation and evaluation.

| | | | | | | | | Mould | |
|---|---|---|---|---|---|---|---|---|---|
| | | | | | | | Release Agent | Appearance | |
| | Composition | | | | | | Appearance | after concrete | Concrete element |
| | | | Potassium | | | | fluid/thick | removal | appearance |
| | | | salt of | Unsaponified | Total | | clear/turbid | + = clean | + = smooth surface |
| | Glycerol | PEG200 | Sylavtal 10 | Sylvatal 10 | Solids | Water | homogeneous/phase | +/− = little built up | +/− = some stripes |
| Number | wt. % | wt. % | wt. % | wt. % | (wt. %) | (wt. %) | separation | − = severe built up | − = severe stripes |
| 14 | | | 20.0 | 2.0 | 22.0 | 78.0 | fluid/turbid/homogeneous | +/− | − |
| 15 | | 2.0 | 19.6 | 2.0 | 23.6 | 76.4 | fluid/turbid/homogeneous | +/− | − |
| 16 | 5.0 | | 19.0 | 1.9 | 25.9 | 74.1 | fluid/turbid/homogeneous | − | − |
| 17 | | | 15.0 | 4.0 | 19.0 | 81.0 | fluid/turbid/homogeneous | − | − |
| 18 | | 2.0 | 14.7 | 3.9 | 20.6 | 79.4 | fluid/turbid/homogeneous | +/− | + |
| 19 | 5.0 | | 14.3 | 3.8 | 23.1 | 77.0 | fluid/turbid/homogeneous | +/− | + |
| 20 | 5.0 | | 14.3 | 3.8 | 23.1 | 77.0 | fluid/turbid/homogeneous | − | +/− |
| 21 | 10.0 | | 13.5 | 3.6 | 27.1 | 72.9 | fluid/turbid/homogeneous | − | − |
| 22 | | 1.0 | 14.9 | 4.0 | 19.8 | 80.2 | fluid/turbid/homogeneous | +/− | + |
| 23 | 5.0 | 2.0 | 14.0 | 3.7 | 24.7 | 75.3 | fluid/turbid/homogeneous | − | + |
| 24 | | | 10.0 | 6.0 | 16.0 | 84.0 | fluid/turbid/homogeneous | − | + |
| 25 | 5.0 | | 9.5 | 5.7 | 20.2 | 79.8 | fluid/turbid/homogeneous | − | + |
| 26 | | 2.0 | 9.8 | 5.9 | 17.7 | 82.3 | fluid/turbid/homogeneous | +/− | + |

| Number | Sample Composition |
|---|---|
| 14 | Sylvatal 10 Soap; Made by saponification of Sylvatal10 with Potassium Hydroxide. A 2% excess of Sylvatal 10 |
| | was used, see example 2. |
| 15 | Made by mixing Sylvatal 10 Soap from example 2 with PEG200. |
| 16 | Made by mixing Sylvatal 10 Soap from example 2 with Glycerol |
| 17 | Sylvatal 10 Soap; Made by saponification of Sylvatal 10 with Potassium Hydroxide. A 4% excess of Sylvatal 10 |
| | was used, see example 3 |
| 18 | Made by mixing Sylvatal 10 Soap from example 3 with PEG200. |
| 19 | Made by mixing Sylvatal 10 Soap from example 3 with Glycerol. |
| 20 | Made by mixing Sylvatal 10 Soap from example 3 with Glycerol. |
| 21 | Made by mixing Sylvatal 10 Soap from example 3 with Glycerol |
| 22 | Made by mixing Sylvatal 10 Soap from example 3 with PEG200. |
| 23 | Made by mixing Sylvatal 10 Soap from example 3 with Glycerol and PEG200. |
| 24 | Sylvatal 10 Soap; Made by saponification of Sylvatal10 with Potassium Hydroxide. A 6% excess of Sylvatal 10 |
| | was used. |
| 25 | Made by mixing Sylvatal 10 Soap from experiment 23 with glycerol. |
| 26 | Made by mixing Sylvatal 10 Soap from experiment 23 with PEG200. |

| | |
|---|---|
| Release agent appearance: | Appearance of the concrete release agent after 24 hrs |
| Mould Apperance after concrete removal | After the concrete element is removed out the mould some concrete may remain in te mold. |
| | This is referred to as built up. |
| Concrete element Appearance | After removal from the mould the element istself is evauated on its appearance. |

The present disclosure presents a release agent based on a mixture of saponified and unsaponified DTO. This achieved by adding an excess of DTO during the saponification reaction so that in the final formulation a mixture of saponified and unsaponified DTO is present.

Without being limited by theory, it is believed that saponified DTO will act as a surfactant and that unsaponified DTO in combination with Glycerol and PEG200 act as flow improvers. After application of the release agent to the mould, the unsaponified DTO in combination glycerol or PEG200 gives the release agent a liquid instead of a waxy/solid consistency. The liquid consistency also remains after evaporation of the water. As a result, the release agent distributes more evenly and more uniform over the mould surface ultimately resulting in a concrete element with no streaks or unevenesses. It is believed that this is approach and utilization of DTO with or without in combination with glycerol or PEG200 is novel. Another advantage of glycerol is that increases the cold temperature stability.

Simple process of making: The product is essentially made in one step by saponifying Distilled Tall Oil. This is a simpler process than the preparation of an emulsion as is done with the manufacture of Emulfix LL.

More cost effective raw materials. Prices for TOFA or DTO or saponified TOFA or DTO are typically lower than for fatty acid esters.

More effective product. The product is equal or better in performance than the competitive product Emulfix LL which has a higher solids or active ingredients level. The performing samples (# 14 through 26) in table 1 have an active compound composition between 17.4 and 27.1 wt. % whereas Emulfix LL has an active compound concentration of 36 wt. %. The latter is determined with a Mettler Toledo HR73Halogen Moisture Analyzer at 100° C. for 30 minutes.

Ease of Cleaning Since the developed products are soaps they are easily removed with water. And they are more easily removed than products based on mineral or vegetable oil or fatty acid esters, although those type of materials may be utilized in the present invention.

### Example 2

In a 2 L three necked reaction flask, equipped with thermometer and overhead stirrer is dissolved 33.2 g potassium hydroxide (85% pure) in 817 g demineralized water. After the potassium hydroxide is dissolved, the reaction mixture is heated to 87° C. Subsequently, 150 g of Sylfat2 having an Acid Value of 195 mg KOH/g, was slowly added using a dropping funnel over 1 hour period. Once a clear and homogeneous solution is obtained a sample is taken for solid content analysis**. If needed additional DTO, KOH, or water is added or water distilled off to obtain a 15% solid content soap.

### Example 3

63.7 g of potassium hydroxide (85% pure) was dissolved in 1200 g of dematerialized water in a 2 L reaction flask, equipped with thermometer and an overhead stirrer. After all potassium hydroxide is dissolved the reactor is carefully heated to 87° C. Once the temperature is 87° C., 204 g Sylfat 2LT and 96 g Sylvatal 25/30 *(Acid Value of this mixture is 186.98 mg KOH/g sample) were added using a dropping funnel over a 1-hour period. Once a clear and homogeneous solution is obtained, a sample is taken for solid content analysis**. Using the solid content result, dematerialized water is added to obtain a 20% solid content soap. In the present example, an addition of 85.0 g of dematerialized water was required. The reactor is allowed to homogenize after which a sample is taken again for solid content analysis. After the solid content is confirmed to be 20%, the solid content is then increased to 22% using the earlier described mixture of Sylfat 2LT and Sylvatal 25/30*, in order to obtain an excess of 2% unsaponified distilled tall oil. In the present example 23.6 g Sylfat 2LT and 11.1 g Sylvatal 25/30* were added in order to obtain a final solid content of about 22%. After the product was homogenized for another hour, it was cooled down to room temperature and discharged.

### Example 4

Into a 2 L reaction flask, equipped with thermometer and an overhead stirrer, 47.8 g of potassium hydroxide (85% pure) was dissolved in 1275 g of demineralized water. After all potassium hydroxide is dissolved the reactor is carefully heated to 87° C. Once the temperature is 87° C., 153 g Sylfat 2LT and 72 g Sylvatal*(Acid Value of this mixture is 186.98 mg KOH/g sample) were added using a dropping funnel over a 1-hour period. Once a clear and homogeneous solution is obtained a sample is taken for solid content analysis**. Using the solid content result, dematerialized water is added to obtain a 15% solid content soap. In the present example, an addition of 89.3 g of dematerialized water was required. The reactor is allowed to homogenize after which a sample is taken again for solid content analysis. After the solid content is confirmed to be 15%, the solid content is then increased to 19% using the earlier described mixture Sylfat 2LT and Sylvatal 25/30*, in order to obtain an excess of 4% unsaponified distilled tall oil. In the present example 49.6 g Sylfat 2LT and 23.3 g Sylvatal 25/30* were added in order to obtain a final solid content of about 19%. After the product was homogenized for another hour, it was cooled down to room temperature and discharged.

### Example 5

31.9 g of potassium hydroxide (85% pure) was dissolved in 1350 g of demineralized water in a 2 L reaction flask, equipped with a thermometer and an overhead stirrer. After all potassium hydroxide is dissolved the reactor is carefully heated to 87° C. Once the temperature is 87° C., 102 g Sylfat 2LT and 48 g Sylvatal* (Acid Value of this mixture is 186.98 mg KOH/g sample) were added using a dropping funnel over a 1-hour period. Once a clear and homogeneous solution is obtained a sample is taken for solid content analysis**. Using the solid content number a final addition of dematerialized water is made in order to obtain a 10% solid content soap. In the present example, an addition of dematerialized water was not required. The solid content is then increased to 16% using the earlier described mixture, in order to obtain an excess of 6% unsaponified distilled tall oil. In the present example 63.2 g Sylfat 2LT and 29.8 g Sylvatal 25/30* were added in order to obtain a final solid content of about 16%. After the product was homogenized for another hour, it was cooled down to room temperature and discharged.
* Using Sylfat2 and Sylvatal 25/30 in these proportions results in a product which identical to a Distilled Tall Oil grade manufactured by Arizona Chemical and sold as Sylvatal 10.

** Solid content is determined using a Mettler Toledo HR73Halogen Moisture Analyzer. In order to determine the solid content 1.5 g of sample is heated at 150° C. for 15 min, after which the remaining amount of solids is reported.

### Example 6

Additional concrete release agents were made and evaluated; see table 4 sample number 27 through 37.

Aim of this additional work was to further increase the performance and to make a product equal in performance compared to the reference (sample 1, Emulfix LL). A next series of soaps was made following the procedure in example 3 and 4. To these soaps were added various additives in various proportions, see table 4.

Best results were obtained with sample 36 which contains 14.7% of the potassium salt of Sylvatal 10, 3.9% unsaponified Sylvatal 10 and 2.0% PEG-200 Mono Oleate. This sample showed performance equal to the reference Emulfix LL®.

TABLE 4
Sample Preparation and evaluation.

| | | | | | | | | | Mould | |
|---|---|---|---|---|---|---|---|---|---|---|
| | Composition | | | | | | | | Appearance | |
| | Potassium | | | | PEG- | | | | after concrete | Concrete element |
| | Salt of | | | | 200 | | | Release Agent | removal | appearance |
| | Sylavtal | Unsaponified | | Stearic | Mono | Total | | Appearance | + = clean | + = smooth surface |
| | 10 | Sylavatal 10 | TEG | Acid | Oleate | Solids | Water | fluid/thick | +/− = little built up | +/− = some stripes |
| Number | wt. % | wt. % | wt. % | wt. % | wt. % | wt. % | wt. % | clear/turbid/separation | − = severe built up | − = severe stripes |
| 1 | | | | | | | | fluid/turbid/homogeneous | + | + |
| 27 | 9.80 | 5.88 | 2.00 | | | 17.68 | 82.32 | fluid/turbid/homogeneous | +/− | +/− |
| 28 | 9.75 | 5.85 | 2.00 | 0.50 | | 18.10 | 81.90 | fluid/turbid/homogeneous | +/− | + |
| 29 | 9.73 | 5.84 | 2.00 | 0.75 | | 18.31 | 81.69 | fluid/turbid/homogeneous | +/− | + |
| 30 | 9.65 | 5.79 | 2.00 | 0.50 | 1.00 | 18.94 | 81.06 | fluid/turbid/homogeneous | +/− | +/− |
| 31 | 9.50 | 5.70 | 2.00 | 1.00 | 2.00 | 20.20 | 79.80 | fluid/turbid/homogeneous | +/− | +/− |
| 32 | 9.55 | 5.73 | 2.00 | 0.50 | 2.00 | 19.78 | 80.22 | fluid/turbid/homogeneous | +/− | +/− |
| 33 | 9.60 | 5.76 | 2.00 | | 2.00 | 19.36 | 80.64 | fluid/turbid/homogeneous | +/− | +/− |
| 34 | 9.55 | 5.73 | 2.00 | 0.50 | 2.00 | 19.78 | 80.22 | fluid/turbid/homogeneous | +/− | +/− |
| 35 | 9.53 | 5.72 | 2.00 | 0.75 | 2.00 | 19.99 | 80.01 | fluid/turbid/homogeneous | +/− | +/− |
| 36 | 14.70 | 3.92 | | | 2.00 | 20.62 | 79.38 | fluid/turbid/homogeneous | + | + |
| 37 | 9.80 | 5.88 | | | 2.00 | 17.68 | 82.32 | fluid/turbid/homogeneous | +/− | +/− |

| Number | Sample Composition |
|---|---|
| 1 | Reference (Emulfix LL ®, Concrete Release Agent from Degussa) |
| 27 | Made by mixing Sylvatal 10 Soap from example 4 with TEG |
| 28 | Made by mixing Sylvatal 10 Soap from example 4 with TEG and Stearic Acid |
| 29 | Made by mixing Sylvatal 10 Soap from example 4 with TEG and Stearic Acid |
| 30 | Made by mixing Sylvatal 10 Soap from example 4 with TEG, Stearic Acid and PEG200 Mono Oleate |
| 31 | Made by mixing Sylvatal 10 Soap from example 4 with TEG, Stearic Acid and PEG200 Mono Oleate |
| 32 | Made by mixing Sylvatal 10 Soap from example 4 with TEG, Stearic Acid and PEG200 Mono Oleate |
| 33 | Made by mixing Sylvatal 10 Soap from example 4 with TEG and PEG200 Mono Oleate |
| 34 | Made by mixing Sylvatal 10 Soap from example 4 with TEG, Stearic Acid and PEG200 Mono Oleate |
| 35 | Made by mixing Sylvatal 10 Soap from example 4 with TEG, Stearic Acid and PEG200 Mono Oleate |
| 36 | Made by mixing Sylvatal 10 Soap from example 3 and PEG200 Mono Oleate |
| 37 | Made by mixing Sylvatal 10 Soap from example 4 and PEG200 Mono Oleate |

| | |
|---|---|
| TEG | TriEthyleneGlycol |
| PEG-200 Oleate | PolyEthyleneGlycol Mono Oleate. |

The above examples 1-6 show that:
release agents can be made from a mixture of saponified and unsaponified DTO.
additional additives(as discussed above) are beneficial to further boost product performance.

Various additives have been evaluated and the best performance was observed with a soap containing 14.7% of the potassium salt of Sylvatal 10, 3.9% unsaponified Sylvatal 10 and 2.0% PEG-200 Mono Oleate.

Looking back at the work carried out has shown that effective release aids can be made from a mixture of saponified and unsaponified DTO. The use of additives has shown to further boost product performance. Depending on the application, a different additive or different set of additives may be necessary in combination thereof. In this case, for concrete mould release PEG 200 Mono Oleate has shown to be the most effective.

Secondly, it is anticipated that various additives may be used to improve process and shelf life stability, like possibly defoamers and for example anti-freezing agents.

### Example 7

### Soap Preparation

95 g of Potassium Hydroxide (85% pure) was dissolved in 4465 g of demineralised Water. The solution is then heated to 87° C. after which a mixture of 295 g Sylfat 2LT and 140 g of Sylvatal 25/30 was added by means of a dropping funnel over a 1.5 hour period. After addition the soap was allowed to homogenize for 30 minutes after which the solid content was determined. In this specific case the solid content was found to be 9.39% and therefore a correction was made to the batch in order to obtain 10% solids. The correction consisted of 20.9 g Sylfat 2LT, 10.5 g of Sylvatal 25/30 and 9.3 g KOH. After homogenizing for 30 minutes the solid content was determined and was found to be 10.07%. The batch was then allowed to cool and discharged (lab book reference AO-370-38).

### Example 8

### Concrete Release Agent

Using the earlier described fully saponified DTO soap of Example 7, samples were prepared for field trials. Therefore 750 g of soap was mixed with 135 g Uniflex 306E. Although these samples did have the proper releasing properties e.g. no pinhole formation or dust build up, the mixture was found not to be stable and therefore impractical to use.

### Example 9

### Concrete Release Agent

In order to stabilize the concrete release agent as described in Example 8 various surfactant screenings have been performed. Different surfactant chemistries have been applied however, best results in terms of shelf life stability and releasing properties were seen using a surfactant based on Ethoxylated Oleic Acid (Serdox NOG 440 obtained from Elementis Specialties).

The surfactants screened include from Kao Chemicals: Amidet TEC N, Akyporox RLM80V, Akyporox RLM40V, Akypo RO20, Akypo RO50, Akypo RO90, Akypo LF4, TEC AN, Fosfodet FJZ903, TAMEA 20, Amed A15, Akypo Gene CL756, Akypo Soft 45, and Ethoxylated Glycerine, and from Elementis Specialties: Serdox NOG440, Servo CM6030, and Serdox NOL3

The formulation, as it has been made several times, currently consists of 750 g of a fully saponified Sylvatal 10 soap solution with a solids content of 10%, 135 g of Uniflex 306E and 30 g of the earlier mentioned surfactant. Emulsions have been made by direct methods as well as by inversion methods.

### Example 10

### One Pot Synthesis without Surfactant

A 1-litre reactor was charged with 135 g Uniflex 306E, 51 g Sylfat 2 and 24 g Sylvatal 25/30. The content of the reactor was homogenized thoroughly and then heated to approximately 90° C. A solution of 16.4 g Potassium hydroxide in 20 g water was added to the reactor and allowed to mix into the mixture for 30 minutes. Once the entire potassium hydroxide solution was added, the mixture appeared to be brown, hazy but homogeneous. 639 g water was charged into a dropping funnel and addition was started slowly. Upon addition of the water small white lumps appeared in the mixture. Once the system had fully inverted the water addition was stopped and the high viscosity mixture was allowed to homogenize for 30 minutes. During this inversion stage the viscosity build rapidly toward clay type viscosities and the color changed to off white. Water addition was then resumed and the remaining water was added in 90 minutes. After the water addition was completed, the emulsion was cooled to room temperature after which it was discharged through a 100 micron filter screen. The final product was a turbid white emulsion with a blue shade.

As used throughout, ranges are used as a short hand for describing each and every value that is within the range, including all subranges therein.

Numerous modifications and variations on the present invention are possible in light of the above teachings. It is, therefore, to be understood that within the scope of the accompanying claims, the invention may be practiced otherwise than as specifically described herein.

All of the references, as well as their cited references, cited herein are hereby incorporated by reference with respect to relative portions related to the subject matter of the present invention and all of its embodiments

1-5. (canceled)

6. A mold construct, comprising
a mold;
a moldable material; and
a release layer positioned between the mold and the moldable material, wherein the release layer comprises:
a soap component comprising a saponified component comprising: (i) an at least partially saponified saturated or unsaturated, monocarboxylic aliphatic hydrocarbon or derivative thereof having a linear, branched, and/or cyclic chain, a dimer thereof, a trimer thereof; or (ii) an at least partially saponified mixture of rosin acids; or, a release enhancing component;
wherein the saponified component is present in an amount that is from 1 to 50 wt % based upon the total weight of the composition.

7. The mold construct according to claim 6, wherein at least a portion of the release layer is contact with at least a portion of the mold.

8. The mold construct according to claim 6, wherein at least a portion of the release layer is contact with at least a portion of the moldable material.

9. A method of making a molded article, comprising
removing a molded article from a mold construct once the moldable material has at least partially dried and/or solidified, wherein the mold construct comprises:
a mold;
a moldable material; and
a release layer positioned between the mold and the moldable material,
wherein the release layer comprises:
a soap component comprising a saponified component comprising: (i) an at least partially saponified saturated or unsaturated, monocarboxylic aliphatic hydrocarbon or derivative thereof having a linear, branched, and/or cyclic chain, a dimer thereof, a trimer thereof; or (ii) an at least partially saponified mixture of rosin acids; or,
a release enhancing component;
wherein the saponified component is present in an amount that is from 1 to 50 wt % based upon the total weight of the composition.

10. A molded article made from the process according to claim 9.
